(19) United States
(12) Patent Application Publication
(10) Pub. No.: US 2026/0233469 A1
(43) Pub. Date: Aug. 13, 2026

(54) WELDING JAW AND METHOD FOR THERMAL WELDING

(71) Applicant: GEORG MENSHEN GMBH & CO. KG, FINNENTROP (DE)

(72) Inventors: MARTI NOGUE I ARBUSA, BARCELONA (ES); MARTI ESQUERDO FOSSAS, BARCELONA (ES)

(73) Assignee: GEORG MENSHEN GMBH & CO. KG, FINNENTROP (DE)

(21) Appl. No.: 19/153,343

(22) PCT Filed: Jan. 10, 2024
(86) PCT No.: PCT/EP2024/050473

§ 371 Date: Aug. 4, 2025

(30) Foreign Application Priority Data
Feb. 20, 2023 (ES) P202330124

(51) Int. Cl. B29C 65/20; B29C 65/00; B29L 31/00; B65D 25/40

(52) U.S. Cl. CPC B29C 65/20; B29C 66/81422; B29C 66/81423; B65D 25/40; B29C 66/8511; B29L 2031/7128

(57) ABSTRACT

A welding jaw for thermally welding a pouch wall made of a plastic film to a welding region of a spout made of a plastic. The welding jaw includes a jaw body and a pressing element. The jaw body is connected to a heat source. The jaw body has a first pressing surface via which the pouch wall is pressable against the welding region of the spout in a surface area to be welded. The pressing element is arranged on or is fastened to the jaw body. The pressing element has a second pressing surface adjacent to the first pressing surface of the jaw body via which the pouch wall is pressable toward the welding region of the spout or toward a center longitudinal axis of a pouring channel in a surface area not to be welded which is adjacent to the surface area to be welded.

### CROSS REFERENCE TO PRIOR APPLICATIONS

This application is a U.S. National Phase application under 35 U.S.C. § 371 of International Application No. PCT/EP2024/050473, filed on Jan. 10, 2024 and which claims benefit to Spanish Patent Application No. 202330124, filed on Feb. 20, 2023. The International Application was published in German on Aug. 29, 2024 as WO 2024/175260 A1 under PCT Article 21(2).

### FIELD

The present invention relates to a welding jaw for thermally welding a pouch wall made of plastics film to a welding region of a spout made of plastic. The present invention also relates to a method for thermally welding pouch walls made of plastics film to a welding region of a spout made of plastic.

### BACKGROUND

The prior art describes pouch packages, in particular what are referred to as squeeze pouches, where a spout is welded in between two oppositely situated wall regions of the pouch so that it is possible to extract the contents of the pouch through the pouring channel of the spout. The walls can, for example, be made of respective film layers.

In the prior art and, for example, also in the case of the present invention, such a spout comprises a pouring channel, the channel wall of the pouring channel on the first end region being in the form of a spout connection piece and the channel wall being surrounded on the second end region by a welding region, the welding region having two welding arms which extend to a respective welding arm end in opposite directions perpendicular to the channel axis of the pouring channel, in particular which extend away from the channel wall in the second end region, and each welding arm has welding zones, e.g., multiple rib elements, which are attached to the channel wall of the second end region, for example, are spaced apart from one another in the direction of the channel axis, and has a first welding zone extending between the channel wall and the welding arm end on a first welding side and a second welding zone extending between the channel wall and the welding arm end on a second welding side. The first and second welding zones converge toward the welding arm end. In one possible embodiment, the welding zones may extend at least partially in a straight line or in a flat form. The regions extending in a straight line of the first welding zone and the second welding zone form an acute angle therebetween in such a case. The welding zones can, however, also be curved.

Such spouts are described in the prior art, for example, from DE 10 2017 009 693 A1. The spouts are intended to be welded in between two walls, for example, film layers, of a pouch, in particular a film pouch, which contains, for example, a foodstuff, in particular a flowable foodstuff. Due to the convergent form of the welding zones in the two welding arms, the welding region has a shape which tapers from the channel axis toward the welding arm ends, in particular which is frequently also referred to as boat-shaped, the tapering being in a plane perpendicular to the channel axis.

Welding jaws, which apply welding energy from two oppositely situated welding sides through the respective wall of the pouch to the welding zones of the welding region, weld the welding zones to the respective wall on each of the two welding sides.

The welding sides are thus two oppositely situated sides of the welding region. The welding sides lie on either side of a plane comprising the channel axis and the two welding arm ends. The channel axis in this case is the axis of longitudinal extent of the pouring channel, that axis running through the spout.

This plane can also be referred to as a frontal plane and corresponds to a plane parallel to the walls of the pouch, in particular the unfilled pouch.

A removable closure, for example, a cap, is typically arranged on the one end region which, during use while the pouch is upright, forms the upper end region in its function as a spout connection piece. The removable closure can, for example, be fastened or fastenable to a threaded connection on the spout connection piece and removable.

The second end region, which forms the welding region, is the lower end region of the spout during use. The present invention can, for example, relate to the application of the method according to the present invention to such aforementioned spouts and to the use of such aforementioned spouts in conjunction with the welding jaws according to the present invention.

When the welding jaws are applied to the welding regions of such spouts, the heated pressing surface of the welding jaws comes into contact with and heats the wall. The wall is also moved towards the welding region of the spout by the movement of the welding jaw. This causes the heated surface area of the wall to be displaced in relation to non-heated surface areas and the heated surface area to be stretched where it transitions to the non-heated surface area, which is not intended for welding, of the wall, which can lead to leaks in the wall after the welding. Such leaks thus occur mainly in unwelded surface areas which directly adjoin welded surface areas of the wall.

### SUMMARY

An aspect of the present invention is to provide a welding jaw of the type mentioned above and a method for thermal welding so that the stretching of the wall in the transition region between welded and unwelded surface areas of the wall is reduced, for example, eliminated, and the risk of leaks is thus reduced, for example, eliminated.

In an embodiment, the present invention provides a welding jaw for thermally welding a pouch wall which is made of a plastic film to a welding region of a spout which is made of a plastic. The welding jaw includes a jaw body and a pressing element. The jaw body is configured to be connected to a heat source. The jaw body comprises a first pressing surface via which the pouch wall can be pressed against the welding region of the spout in a surface area to be welded. The pressing element is arranged on the jaw body or is fastened to the jaw body. The pressing element comprises a second pressing surface which is adjacent to the first pressing surface of the jaw body and via which the pouch wall can be pressed toward the welding region of the spout or toward a center longitudinal axis of a pouring channel in a surface area that is not to be welded which is adjacent to the surface area that is to be welded.

### BRIEF DESCRIPTION OF THE DRAWINGS

The present invention is described in greater detail below on the basis of embodiments and of the drawings in which:

FIG. 1 shows a first view of a starting position of a welding-jaw body of the prior art which can be heated by a heating element;

FIG. 2 shows a second view of a starting position of a welding-jaw body of the prior art which can be heated by a heating element;

FIG. 3 shows a first view of the end position of the welding-jaw body of the prior art;

FIG. 4 shows a second view of the end position of the welding-jaw body of the prior art;

FIG. 5 shows a first view of a starting position of a welding-jaw body of the present invention which can be heated by a heating element;

FIG. 6 shows a second view of a starting position of a welding-jaw body of the present invention which can be heated by a heating element;

FIG. 7 shows a first view of the end position of the welding-jaw body of the present invention;

FIG. 8 shows a second view of the end position of the welding-jaw body of the present invention;

FIG. 9 shows the pressing element in the form of a flat element/plate, the large surfaces of which lie parallel to the oppositely situated surfaces of the jaw body, and between which the first pressing surface is formed beyond the thickness;

FIG. 10 shows a view of a specific embodiment of a welding jaw according to the present invention without illustrating the heat source on the jaw body, where the respective concave recesses are mirror-symmetrical with respect to a plane which runs through the recess bottom and is perpendicular to the surfaces; and

FIG. 11 shows a view of a specific embodiment of a welding jaw according to the present invention without illustrating the heat source on the jaw body, where the respective concave recesses are mirror-symmetrical with respect to a plane which runs through the recess bottom and is perpendicular to the surfaces.

### DETAILED DESCRIPTION

The present invention provides a welding jaw for thermally welding a pouch wall made of plastics film to a welding region of a spout made of plastic, comprising a jaw body which can be connected to a heat source which has a pressing surface with which the pouch wall can be pressed against the welding region of a spout in a surface area to be welded.

The pressing surface of the jaw body can in particular be heated indirectly by the heat source, in particular to a temperature above the melting temperature of the material of the wall and of the welded-in region, on account of the thermal conductivity of the jaw body, which can, for example, be made of metal.

The wall and the welding region are heated by pressing the wall against the welding region via the heated pressing surface, in particular above their respective melting temperatures, so that these two parts are integrally bonded on their mutually facing surfaces under the effect of the welding pressure exerted.

The present invention also provides a method for thermally welding pouch walls made of plastics film to a welding region of a spout made of plastic, during which method two oppositely situated welding jaws, each having a jaw body connected to a heat source, are moved toward the welding region from opposite directions, each jaw body having a pressing surface with which the pouch wall lying between the pressing surface and the welding region is pressed against the welding region of the spout in a surface area to be welded.

The present invention provides that, in the case of a welding jaw of the type mentioned above, a pressing element is arranged on the jaw body, in particular fastened to the jaw body, the pressing element having a second pressing surface which is adjacent to the first pressing surface of the jaw body and via which the pouch wall can be pressed toward the welding region of a spout in a surface area that is not to be welded and is adjacent to the surface area that is to be welded.

Pressing surfaces denote those surfaces of the welding jaw that can be used during operation of the welding jaw as intended, in particular when the welding jaw is moved toward a welding region of a spout, to exert a force on the pouch wall in order to move the wall region contacted by the respective pressing surface toward the welding region of the spout.

The present invention provides a method of the type mentioned above where, arranged on the jaw body, in particular fastened to the jaw body, is a pressing element having a second pressing surface, which is adjacent to the first pressing surface of the jaw body and via which the pouch wall is pressed toward the welding region of the spout in a surface area that is not to be welded and is adjacent to the surface area that is to be welded.

A pressing of the wall toward the welding region of the spout in the surface area that is not to be welded is understood to mean that at least a gap between the wall outside of the surface area that is to be welded and the welding region is thereby reduced in that the second pressing surface pushes the wall along in this area, in particular toward a center plane, about which the spout is arranged and which comprises the center longitudinal axis, which runs through the pouring channel of the spout. This does not imply that this surface area comes into a position directly opposite the welding region. Only the wall surface area that is to be welded comes into a position directly opposite the welding region until it makes contact therewith.

A surface area which lies outside of/adjacent to the wall surface area that is to be welded, i.e., which is not to be welded to the welding region, can, for example, lie underneath the welding region on the opposite side of the welding region to the pouring channel in an axial direction of the extent of the pouring channel of the spout and/or next to the welding region in a direction radial to the direction of extent of the pouring channel, in particular radially on the outside next to the radially outer ends of radially outwardly tapering welding arms of the welding region.

In contrast to the prior art, the present invention thus achieves the effect that the welding jaw not only contacts those wall surface areas that are to be welded, but also contacts those surface areas that are not to be welded and pushes them along ahead of it during the movement. This prevents a relative displacement from occurring between the surface areas that are to be welded and those that are not to be welded; these surface areas in particular do not buckle and stretched portions of the heated surface area at the transition to the surface area that is not to be welded are furthermore avoided so as to thus overcome the aforementioned disadvantages.

The method of the present invention provides that the second pressing surface can, for example, be kept at a temperature which is lower than the temperature of the first pressing surface, in particular so that the second pressing surface does not exceed the melting temperature of the wall material and welding-region material that are to be welded, whereas the temperature of the first pressing surface lies above this melting temperature.

This can generally be achieved by cooling the pressing element and/or at least heating it to a lesser extent than the jaw body.

According to the present invention it is possible, for example, for the pressing element or at least the second pressing surface to be made of a material with a lower thermal conductivity than the material of the jaw body.

The effect of this is that although the second pressing surface is also indirectly heated by the heating element via the jaw body, the second pressing surface reaches a lower temperature than the first pressing surface because a less heat flow arrives at the second pressing surface, and the second pressing surface can, for example, also be spaced further apart from the heat source than the first pressing surface is. The pressing element or at least its second pressing surface can, for example, be made of silicone. This material is thermally stable for routine plastics melting temperatures and has a lower thermal conductivity than the material of the jaw body does if it is, for example, made of metal.

As an alternative or in addition to the aforesaid embodiment, it may be provided that the pressing element is indirectly fastened to the jaw body via at least one insulating element which is made of a material with a lower thermal conductivity than the material of the jaw body.

An insulating element also has the effect that, although the second pressing surface is also indirectly heated by the heating element via the jaw body, the second pressing element is held at a lower temperature than the temperature of the first pressing surface because less heat flow arrives at the pressing element, i.e., at the second pressing surface, through the insulating element, and the second pressing surface can, for example, also be spaced further apart from the heat source than the first pressing surface. If an insulating element is used, the pressing element need not have a lower thermal conductivity than the jaw body does and can thus, for example, also be made of metal. The present invention also provides in this case that the thermal conductivity of the pressing element can, for example, be lower than that of the jaw body and that, for example, the pressing element is made of silicone.

In one development of all possible embodiments, the present invention provides that, in the case of the welding jaw, a gap can, for example, be formed between the first and the second pressing surface, in particular a gap in which the pouch wall does not make contact with the welding jaw. Heat transfer to the wall is thus avoided in this region, but the wall on either side of this region is moved by the welding jaw and its two pressing surfaces so as to avoid stresses.

The gap can, for example, be formed by a spacer element which is arranged between the jaw body and the pressing element and which has a surface region set back from the first and the second pressing surface. Such a spacer element can also at the same time form the aforementioned insulating element. The gap may alternatively also be formed in that at least one of the opposite edges of the first and the second pressing surface is formed with a bevel or a radius.

In all possible embodiments, the present invention also provides that the spacer element and/or the insulating element can, for example, be formed by a material containing heat-resistant fibers, in particular glass fibers. Heat-resistant in this case in particular means that the material survives the temperatures present on the jaw body without damage.

In all possible embodiments, the present invention further provides that the pressing element can, for example, be arranged between two holding plates, for example, wherein the holding plate lying between the pressing element and the jaw body forms an aforementioned insulating element and/or an aforementioned spacer element.

This makes it possible, for example, for a pressing element, which is in particular made of silicone, to be arranged between two holding plates and to be fastened to the jaw body on the side facing toward the jaw body via an insulating element. The holding plates then provide, for example, the required stability of the flexible pressing element.

The pressing element can generally be fastened to the jaw body directly or indirectly via one of the aforementioned elements (insulating element, spacer element, holding plate), for example, by screwing.

In all possible embodiments, the present invention provides that the first pressing surface can, for example, be formed between two surfaces of the jaw body that are situated opposite in a thickness direction of the jaw body and the second pressing surface is formed between two surfaces of the pressing element that are situated opposite in a thickness direction of the pressing element, the two oppositely situated surfaces of the jaw body and the two oppositely situated surfaces of the pressing element lying in mutually parallel planes. This can, for example, allow the first pressing surface and/or the second pressing surface to be flat in the thickness direction, at least in the predominant surface area.

The second pressing surface used for the welding operation is in particular formed by a portion of the surface that connects the two oppositely situated surfaces in a direction perpendicular to the surfaces.

In this arrangement, the second pressing surface is situated opposite a pouch-wall surface area which is arranged next to the welding region of the spout on the opposite side of the welding region to the pouring channel when the pouring channel is aligned vertically, i.e., lies underneath the welding region.

The pressing element and thus also its pressing surface can also be fastened to the jaw body so that the second pressing surface is situated opposite a pouch-wall surface area which lies radially next to the end/the tip of a welding arm mentioned above. The present invention may provide pressing elements in both arrangements at the same time on one welding jaw.

The first pressing surface and/or the second pressing surface can, for example, be concave, in particular in a direction perpendicular to the thickness direction or as viewed in cross section parallel to one of the oppositely situated surfaces.

In such a case, the welding region can, for example, be partly engaged around, in particular can be engaged around on one side of the center longitudinal axis of the pouring channel, for example, can be engaged around through at least 170° about the center longitudinal axis, by the first pressing surface. Two oppositely situated welding jaws thus enclose the welding region, one on each side after the welding jaws have been moved toward one another.

In this embodiment, the present invention provides that the first pressing surface and/or the second pressing surface can, for example, be concave by virtue of the fact that the respective pressing surface comprises two partial surfaces, in particular two respective flat partial surfaces, which between them form an angle greater than 90°, for example, greater than 100°, and, for example, transition into one another in a transition region, in particular continuously, for example, with a rounded transition.

Flat partial surfaces can, for example, lie in planes parallel to the center longitudinal axis of the pouring channel.

In a matching combination of spout and welding jaw, the angles with which the welding arms taper at the welding region and the angles formed between the partial surfaces of the first pressing surface are adapted to one another, thus providing a complete contact between the partial surfaces and the welding zones on the welding arms of the welding region. The angle formed between the partial surfaces can, for example, correspond to 180° minus the taper angle of the welding arms.

The present invention provides that the second pressing surface can, for example, be moved so that it partly precedes and/or trails the first pressing surface, and in particular in the case of a pressing surface which extends symmetrically from the inside to the outside, outer surface areas of the second pressing surface are moved so that they precede the outer surface areas of the first pressing surface and inner surface areas of the second pressing surface are moved so that they trail the inner surface areas of the first pressing surface.

In particular therefor, but also for other reasons, the present invention provides that the angle formed between the partial surfaces of the second pressing surface can, for example, be smaller than the angle formed between the partial surfaces of the first pressing surface.

In particular to obtain the aforementioned trailing/leading effect, the present invention provides that the first pressing surface and the second pressing surface can, for example, each form a concave recess, in particular as viewed in cross section parallel to the oppositely situated surfaces, each recess having a recess bottom surrounded by two opposite recess edges, the recess bottoms of the two pressing surfaces and/or the recess edges of the two pressing surfaces not being in line with one another or being offset from one another, in particular as viewed in the correct, intended movement direction of the welding jaws during a welding operation.

The recess bottom can, for example, comprise the region or can, for example, be the region where the partial surfaces transition into one another. The recess edges can, for example, be the regions up and into which the pressing surface, i.e., its two partial surfaces, rise(s) from the recess bottom.

The present invention provides that the recess edges of the second pressing surface can, for example, project beyond the recess edges of the first pressing surface, in particular project toward the welding region, and/or the recess bottom of the second pressing surface can, for example, be set back from the recess bottom of the first pressing surface, in particular with respect to a direction of movement of the welding jaw toward the welding region.

The recess edges of the second pressing surface, in particular as viewed in the direction of the gap between the recess edges, can, for example, form a more elongate plateau than the recess edges of the first pressing surface, the second pressing surface in particular protrudes outward beyond the first pressing surface.

Outward in this case means from the recess bottom beyond the recess edge. The respective pressing surface can, for example, extend from the recess bottom, via the partial surfaces, as far as the highest point of the recess edges, in particular until the recess edges outwardly drop away again. The recess edges of the second pressing surface can, for example, thus outwardly drop away at a later point than the recess edges of the first pressing surface.

The concave first and/or concave second pressing surface can, for example, be symmetrical about a center plane, in particular parallel to the thickness direction.

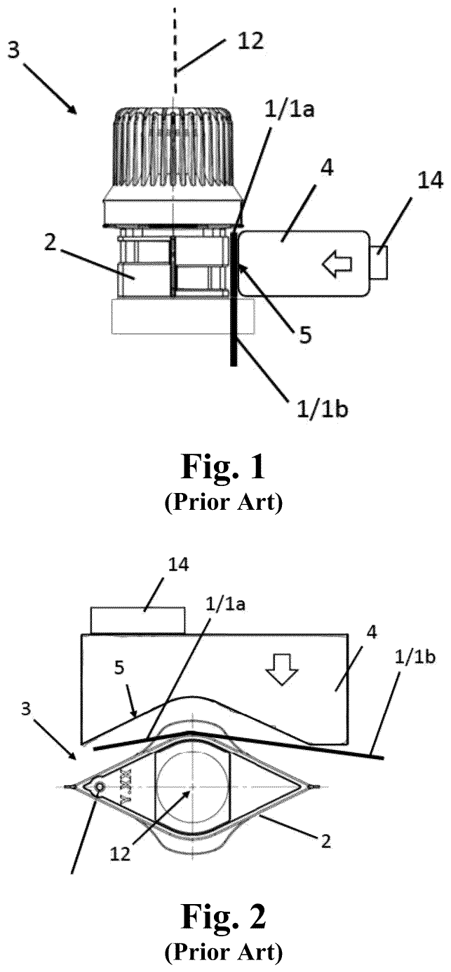

The drawings show the present invention in comparison with the prior art. FIGS. 1 to 4 show the prior art, while FIGS. 5 to 11 show embodiments of the present invention.

FIGS. 1 and 2 schematically shows an initial stage of the thermal welding of a pouch wall 1 to the welding region 2 of a spout 3, the upper region of which in this case has a pouring channel closed with a cap and extending around the center longitudinal axis 12, the pouring channel transitioning into a welding region 2 under/underneath the cap. FIG. 2 thereby shows that the welding region 2 can be designated to be boat-shaped, this being a conventional designation in this technical field. As is known and as is also the case of the present invention, the welding region is formed by two welding arms which extend radially outwardly from the center longitudinal axis 12 in opposite directions and in this case narrow outwardly from the center longitudinal axis, in particular in a plane perpendicular to the center longitudinal axis 12. The radially outwardly facing surfaces of the welding arms form the welding surfaces of the welding region 2, to which welding surfaces the wall is welded.

FIGS. 1 and 2 show views from different directions of a starting position of a welding-jaw body 4 which can be heated by a heating element 14, only one of two jaw bodies 4 being shown, these jaw bodies being opposite to one another about the center longitudinal axis and, for example, moving at the same time in the direction of the arrow shown toward the center longitudinal axis, i.e., toward the welding region 2, and in the process pressing the pouch wall 1 toward the welding region 2.

This causes a wall surface area 1a that is to be welded to come into contact with the first pressing surface 5 of the jaw body 4 and heat up. The arrangement of the welding jaws/jaw bodies 4 and the wall 1 in relation to the spout 3, both in the prior art and in the case of the present invention, is mirror-symmetrical with respect to a plane containing the center longitudinal axis 12 and the tips of the welding arms.

It can be seen in FIGS. 1 and 2 that a wall surface area 1b that is not to be welded and is adjacent to, in particular directly adjoins, the surface area 1a that is to be welded, is contacted neither by the first pressing surface 5 of the jaw body 4 nor by any other element that guides this surface area.

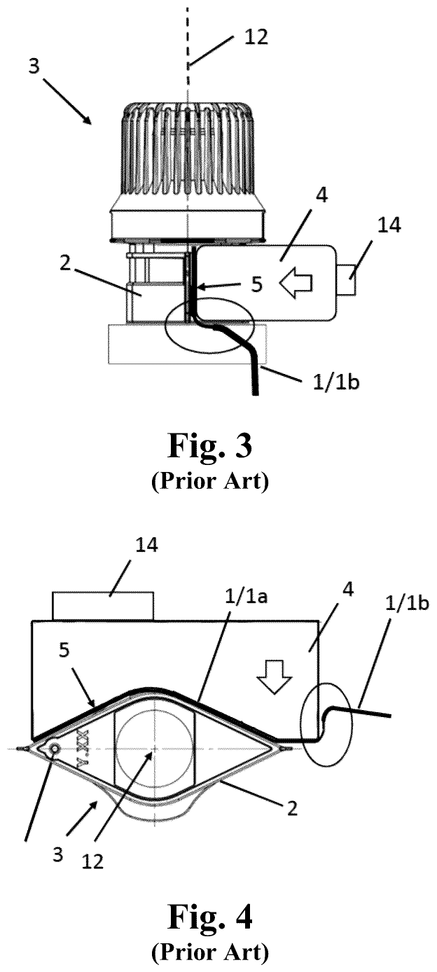

FIGS. 3 and 4 show the problems associated therewith, specifically that an excessive relative movement occurs between the two surface areas 1a and 1b because only the area that is to be welded is pressed toward the welding region 2, i.e., toward the center longitudinal axis 12, but not adjoining areas 1b that are not to be welded, in particular an area which thus trails the movement. The heated surface area 1a to be welded is thus stretched at the transition into the surface area 1b that is not to be welded and thereby weakened. This can lead to leaks in the respective areas circled in FIGS. 3 and 4 in the pouch thereafter produced.

The present invention counters this problem represented in FIGS. 1 to 4 in that arranged on the jaw body 4, in particular fastened to the jaw body 4, for example, by screwing, is a pressing element 6 having a second pressing surface 7, which is adjacent to the first pressing surface 5 of the jaw body 4 and with which the pouch wall 1 can also be pressed toward the welding region 2 of the spout 3, i.e., toward the center longitudinal axis 12 of the pouring channel, in the surface area 1b that is not to be welded and is adjacent to the surface area 1a that is to be welded.

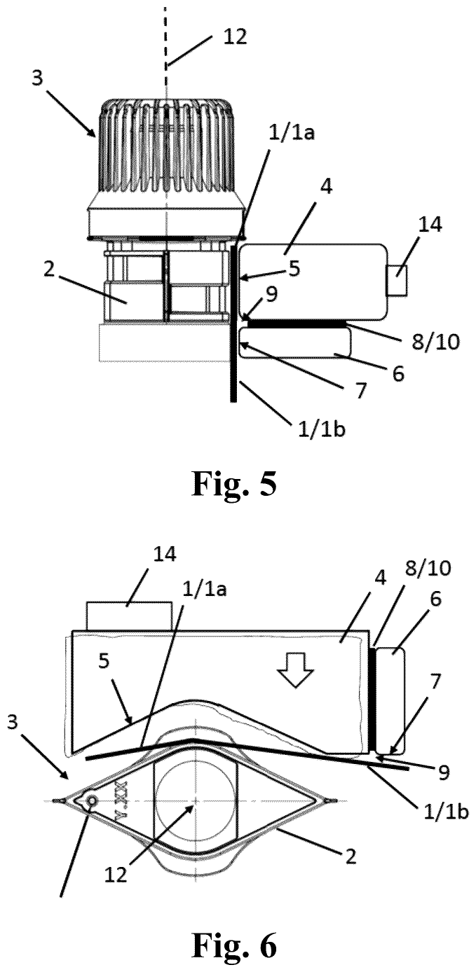

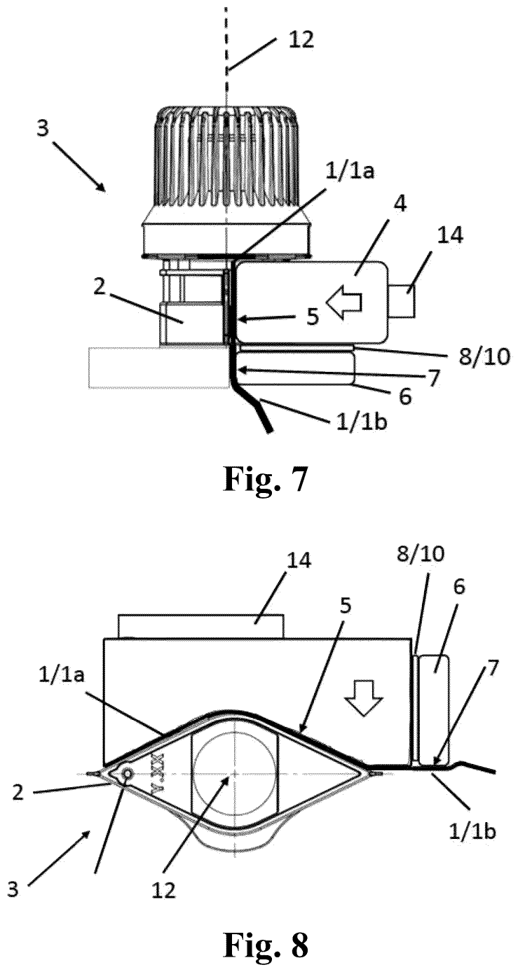

FIGS. 5 and 6 show the starting position of the jaw body 4 in the case of the present invention compared with the starting position of the prior art according to FIGS. 1 and 2, with FIGS. 7 and 8 showing the end position of the jaw body 4 of the present invention compared with the end position in the case of the prior art according to FIGS. 3 and 4.

It can here be seen that the second pressing surface 7, provided by the pressing element 6 and acting on a surface area 1b that is not to be welded and is adjacent to, in particular directly adjoins, the surface area 1a that is to be welded, provides that no relative movement or not so excessive a relative movement occurs between the surface areas 1a and 1b. This reduces or even completely avoids the stretching and weakening of the heated surface area 1a where it transitions into the surface area 1b.

This is advantageously assisted by keeping the second pressing surface 7 of the pressing element 6 at a lower temperature than the first pressing surface 5 of the jaw body 4, in particular a temperature below the melting temperature of the material of the welding region 2 and the wall 1.

This can be achieved by the pressing element 6 having a lower thermal conductivity than the material of the jaw body 4 or by the pressing element being fastened indirectly to the jaw body 4 via an insulating element 8, the insulating element 8 having a lower thermal conductivity than the material of the jaw body 4. The material of the pressing element 6 can, for example, be silicone. A metal or another plastic may also be chosen.

The lower thermal conductivity of the pressing element 6 and/or of the insulating element 8 compared with the material of the jaw body 4 makes the heat flow from the heat source 14 to the second pressing surface 7 much smaller than the heat flow from the heat source 14 to the first pressing surface. Cooling by ambient air is sufficient to keep the temperature of the second pressing surface 7 below the temperature of the first pressing surface. The pressing element 6 may also alternatively be actively cooled in all possible embodiments.

FIGS. 5 to 8 illustrate that it is possible to use multiple pressing elements 6, the second pressing surfaces 7 of which adjoin the first pressing surface 5 in various/multiple directions. For instance, FIGS. 5 and 7 show pressing elements 6 which are next to/underneath the jaw body 4 in the axial direction of the center longitudinal axis 12, with FIGS. 6 and 8 showing pressing elements 6 which lie at least substantially radially next to the jaw body 4, i.e., radially on the outside of the pointed ends of the welding arms. Both types of pressing elements 6 may be used at the same time.

FIGS. 5 and 8 furthermore show a gap 9 between the pressing element 6 and the jaw body 4. This gap 9 may be formed by the insulating element 8 or a spacer element 10 lying between the pressing element and the jaw body. The gap 9 may also be solely or additionally formed by forming the opposite edges of the pressing element 6 and of the jaw body 4 with a bevel or a radius. In the region of the gap 9, the wall 1 does not make contact with either of the pressing surfaces, and as a result this region heats up even less.

In the embodiments in FIGS. 5 to 8, the present invention provides that it is also possible to omit the pressing element arranged on the tip of the welding arms in FIGS. 6 and 8 and provide only one pressing element 6, which is shown in FIGS. 5 and 7, and in particular which contacts, underneath the welding region 2 in the axial direction of the center longitudinal axis 12, a surface area 1b that is not to be welded.

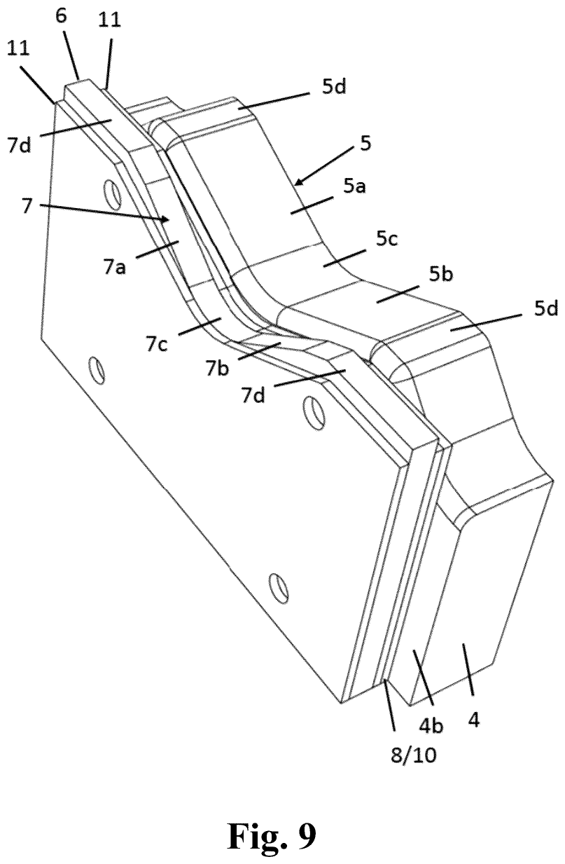

FIGS. 9 to 11 show different views of a specific embodiment of a welding jaw according to the present invention without illustrating the heat source on the jaw body 4. The heat source 14 may generally be fastened to a surface of the jaw body 4 that is not taken up by a pressing element 6.

FIGS. 9 to 11 show that the pressing element 6 is in the form of a flat element/plate, the large surfaces of which, which are spaced apart in the thickness direction, lie parallel to the oppositely situated surfaces 4a and 4b of the jaw body 4, which are spaced apart in its thickness direction and between which the first pressing surface 5 is formed beyond the thickness.

The first and the second pressing surface 5, 7 each form, at least in a sectional plane parallel to the surfaces 4a, 4b, a concave recess with a recess bottom 5c and 7c, respectively, and recess edges 5d and 7d, respectively. Each concave recess rises outward from the recess bottom 5c and 7c to the recess edge 5d and 7d, respectively. Partial surfaces 5a, 5b and 7a, 7b of the first and second pressing surfaces 5, 7, respectively, lie between the recess bottom 5c and 7c and the recess edge 5d and 7d, respectively.

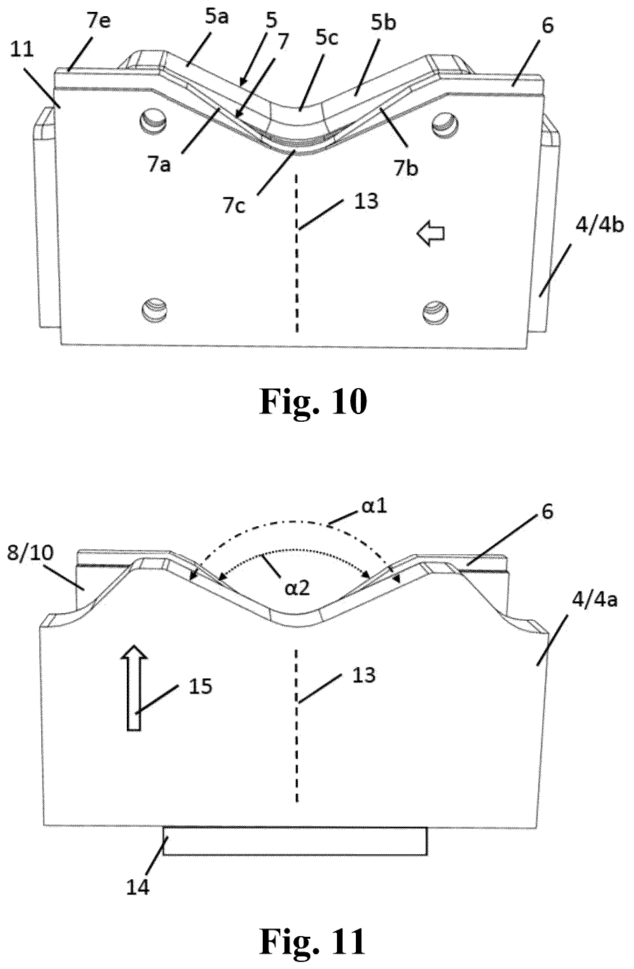

FIGS. 10 and 11 in particular illustrate that the respective concave recesses can, for example, be mirror-symmetrical with respect to a plane which runs through the recess bottom and is perpendicular to the surfaces 4a, 4b. The concave recess of the first pressing surface can, for example, be exactly matched to the outer shape of the welding region 2 of the spout 3 so that the wall 1 can be pressed against the welding region 2 in the area that is to be welded. The concave recess of the first pressing surface 5 can essentially correspond to a negative shape of one of the two oppositely situated welding surfaces of the welding region 2.

The concave recess of the second pressing surface 7 may, in the cross section of a plane parallel to the surfaces 4a and 4b, be identical to, but can, for example, be different from, the concave recess of the first pressing surface 5.

FIGS. 10 and 11 clearly show that the angle α1 formed between the partial surfaces 5a and 5b of the first pressing surface 5 is larger than the angle α2 formed between the partial surfaces 7a and 7b of the second pressing surface 7.

It is also provided here that the recess bottom 7c of the second pressing surface 7 is set back from the recess bottom 5c of the first pressing surface 5, in particular with respect to a movement direction 15 of the welding jaw toward the welding region 2, which is symbolized here by the arrow. As a result, the recess bottom 7c trails the recess bottom 5c in the movement direction 15 during the welding operation.

It is additionally provided that the recess edges 7d of the second pressing surface 7 project beyond the recess edges 5d of the first pressing surface 5, in particular toward the welding region 2. As a result, the recess edges 7d precede the recess edges 5d in the movement direction 15 during the welding operation.

The recess edges 7d of the second pressing surface 7, in particular as viewed in the direction of the gap between the recess edges 7d, also form a more elongate plateau 7e than the recess edges 5d of the first pressing surface 5, in particular the second pressing surface 7 protruding outward beyond the first pressing surface 5.

The design in FIGS. 9 to 11 show that the pressing element 6 can, for example, be held between two holding plates 11, in particular holding plates 11 comprising thermally resistant fibers, for example, glass fibers. This is advantageous when the pressing element is made of an otherwise not sufficiently stable material, for example, silicone. These holding plates 11 also provide thermal insulation with respect to the jaw body 4. The holding plates 11 can, for example, also have a concave recess, for example, reproduce the contour profile of the concave recess of the first pressing surface 5, i.e., in particular be identical, in a center plane 13 parallel to the surfaces 4a, 4b, to the profile of the concave recess of the first pressing surface 5, but can, for example, be further set back parallel thereto, in particular with respect to the movement direction 15 toward the center longitudinal axis 12. The recess bottom of the holding plate 11 may be in line with the recess bottom 7c of the pressing element 6, in particular at least at the deepest point. The unit composed of the pressing element 6 and the two surrounding holding plates 11 is in this case indirectly fastened to the jaw body 4 via the insulating element 8. This leads to a sufficient temperature reduction on the second pressing surface 7.

When performing the method, the temperature of the first pressing surface 5 is generally greater than 190° C., and in the case of the second pressing surface 7, is less than 190° C., for example, less than 170° C., in particular less than 150° C. The temperature of the first pressing surface 5 beyond the surface can, for example, be at least substantially uniform, and the temperature of the second pressing surface 7 can, for example, drop off in a direction away from the first pressing surface 5.

The present invention is not limited to embodiments described herein; reference should be had to the appended claims.

### LIST OF REFERENCE CHARACTERS

1 Pouch wall
1a Surface area that is to be welded
1b Surface area that is not to be welded
2 Welding region
3 Spout
4 Jaw body
4a-b Surface (of jaw body)
5 First pressing surface
5a-b Partial surface (of first pressing surface)
5c Recess bottom (of first pressing surface)
5d Recess edge (of first pressing surface)
6 Pressing element
7 Second pressing surface
7a-b Partial surface (of second pressing surface)
7c Recess bottom (of second pressing surface)
7d Recess edge (of second pressing surface)
7e Elongate plateau (of second pressing surface)
8 Insulating element
9 Gap
10 Spacer element
11 Holding plates
12 Center longitudinal axis
13 Center plane
14 Heat source
15 Movement direction
α1 Angle formed between the partial surfaces of the first pressing surface
α2 Angle formed between the partial surfaces of the second pressing surface

What is claimed is:

1-19. (canceled)

20. A welding jaw for thermally welding a pouch wall which is made of a plastic film to a welding region of a spout which is made of a plastic, the welding jaw comprising:
a jaw body which is configured to be connected to a heat source, the jaw body comprising a first pressing surface via which the pouch wall can be pressed against the welding region of the spout in a surface area to be welded; and
a pressing element which is arranged on the jaw body or which is fastened to the jaw body, the pressing element comprising a second pressing surface which is adjacent to the first pressing surface of the jaw body and via which the pouch wall can be pressed toward the welding region of the spout or toward a center longitudinal axis of a pouring channel in a surface area not to be welded which is adjacent to the surface area to be welded.

21. The welding jaw as recited in claim 20, wherein,
the jaw body is made of a material having a first thermal conductivity,
the pressing element or at least the second pressing surface of the pressing element is made of a material having a second thermal conductivity, and
the second thermal conductivity of the pressing element or of at least the second pressing surface of the pressing element is lower than the first thermal conductivity of the jaw body.

22. The welding jaw as recited claim 21, further comprising:
at least one insulating element which is made of a material having a third thermal conductivity,
the pressing element is fastened to the jaw body indirectly via the at least one insulating element, and
the third thermal conductivity of the at least one insulating element is lower than the first thermal conductivity of the jaw body.

23. The welding jaw as recited in claim 22, wherein a gap is formed between the first pressing surface and the second pressing surface.

24. The welding jaw as recited in claim 23, wherein the gap is formed by an edge of the first pressing surface and/or an edge of the second pressing surface which respectively face each other and is/are formed with a bevel or with a radius.

25. The welding jaw as recited in claim 23, wherein,
the gap is formed by a spacer element which is arranged between the jaw body and the pressing element, and
the spacer element comprises a surface region which is set back from the first pressing surface and from the second pressing surface.

26. The welding jaw as recited in claim 25, wherein the spacer element forms the at least one insulating element.

27. The welding jaw as recited in claim 25, wherein the spacer element and/or the at least one insulating element is formed by a material comprising heat-resistant fibers.

28. The welding jaw as recited in claim 25, further comprising:
two holding plates,
wherein,
the pressing element is arranged between the two holding plates.

29. The welding jaw as recited in claim 28, wherein the one of the two holding plates which lies between the pressing element and the jaw body forms the at least one insulating element and/or the spacer element.

30. The welding jaw as recited in claim 20, wherein,
the first pressing surface is formed between two surfaces of the jaw body that are arranged opposite to each other in a thickness direction of the jaw body, and
the second pressing surface is formed between two surfaces of the pressing element that are arranged opposite to each other in a thickness direction of the pressing element, and
the two surfaces of the jaw body and the two surfaces of the pressing element each lie in mutually parallel planes with respect to each other.

31. The welding jaw as recited in claim 30, wherein the first pressing surface and/or the second pressing surface is flat in the thickness direction at least in a predominant surface area.

32. The welding jaw as recited in claim 30, wherein the first pressing surface and/or the second pressing surface is concave in a direction which is perpendicular to the thickness direction or as viewed in a cross section which is parallel to one of the two surfaces.

33. The welding jaw as recited in claim 32, wherein,
the first pressing surface comprises a concave first pressing surface via the first pressing surface comprising two partial surfaces which between them form an angle >90°, the two partial surfaces transitioning into one another via a transition region that is at least one of continuous and rounded, and/or
the second pressing surface comprises a concave second pressing surface via the second pressing surface comprising two partial surfaces which between them form an angle >90°, the two partial surfaces transitioning into one another via a transition region that is at least one of continuous and rounded.

34. The welding jaw as recited in claim 33, wherein,
the two partial surfaces of the first pressing surface are flat, and
the two partial surfaces of the second pressing surface are flat.

35. The welding jaw as recited in claim 33, wherein the angle formed between the two partial surfaces of the second pressing surface is smaller than the angle formed between the two partial surfaces of the first pressing surface.

36. The welding jaw as recited in claim 33, wherein,
the concave first pressing surface is symmetrical about a center plane which is parallel to the thickness direction, and/or
the concave second pressing surface is symmetrical about a center plane which is parallel to the thickness direction.

37. The welding jaw as recited in claim 32, wherein,
the first pressing surface forms a first pressing surface concave recess as viewed in a cross section which is parallel to the oppositely situated surfaces, the first pressing surface concave recess having a first pressing surface recess bottom which is surrounded by two opposite first pressing surface recess edges,
the second pressing surface forms a second pressing surface concave recess as viewed in a cross section which is parallel to the oppositely situated surfaces, the second pressing surface concave recess having a second pressing surface recess bottom which is surrounded by two opposite second pressing surface recess edges, and
the first pressing surface recess bottom and the second pressing surface recess bottom and/or the two opposite first pressing surface recess edges and the two opposite second pressing surface recess edges are not in line with one another or are offset with respect to one another as viewed from an intended movement direction of the welding jaw during a welding operation.

38. The welding jaw as recited in claim 37, wherein,
the two opposite second pressing surface recess edges project beyond the two opposite first pressing surface recess edges toward the welding region, and/or
the second pressing surface recess bottom is set back from the first pressing surface recess bottom with respect to a direction of movement of the welding jaw toward the welding region.

39. The welding jaw as recited in claim 37, wherein,
the two opposite first pressing surface recess edges form an elongate plateau,
the two opposite second pressing surface recess edges, as viewed in a direction of a gap between the two opposite second pressing surface recess edges, form an elongate plateau, and
the elongate plateau formed by the two opposite second pressing surface recess edges is more elongate than the elongate plateau formed by the two opposite first pressing surface recess edges so that the second pressing surface protrudes outward beyond the first pressing surface.

40. A method for thermally welding a pouch wall which is made of a plastic film to a welding region of a spout which is made of a plastic, the method comprising:
providing two welding jaws which are arranged opposite to each other, each of the two welding jaws comprising a jaw body which is connected to a heat source, each jaw body comprising a first pressing surface;
providing a pressing element which is arranged on the jaw body or which is fastened to the jaw body, the pressing element comprising a second pressing surface which is adjacent to the first pressing surface of the jaw body;
moving the two welding jaws toward the welding region from opposite directions so that the pouch wall lying between the first pressing surface and the welding region is pressed against the welding region of the spout in a surface area to be welded; and
pressing, via a movement of the second pressing surface of the pressing element, the pouch wall toward the welding region of the spout or toward a center longitudinal axis of the pouring channel in a surface area not to be welded which is adjacent to the surface area to be welded.

41. The method as recited in claim 40, wherein the second pressing surface is maintained at a temperature which is lower than a temperature of the first pressing surface.

42. The method as recited in claim 40, wherein the movement of the second pressing surface is provided so that the second pressing surface partly precedes and/or trails the first pressing surface.

43. The method as recited in claim 42, wherein,
the first pressing surface and the second pressing surface are arranged to extend symmetrically from an inside to an outside,
the first pressing surface comprises first pressing surface outer surface areas and first pressing surface inner surface areas, and
the second pressing surface comprises second pressing surface outer surface areas and second pressing surface inner surface areas, and
the method further comprises:
moving the second pressing surface outer surface areas so that the second pressing surface outer surface areas precede the first pressing surface outer surface areas; and
moving the second pressing surface inner surface areas so that the second pressing surface inner surface areas trail the first pressing surface inner surface areas.
